(19) United States
(12) Patent Application Publication
(10) Pub. No.: US 2023/0306335 A1
(43) Pub. Date: Sep. 28, 2023

(54) APPROVAL OBJECT-BASED WORK MANAGEMENT DEVICE AND METHOD

(71) Applicants: Jae Ho CHOI, Seoul (KR); Hyun Kyu CHOI, Seoul (KR); Seo Hyun CHOI, Seoul (KR); Delta PDS CO., LTD., Seoul (KR)

(72) Inventors: Jae Ho CHOI, Seoul (KR); Hyun Kyu CHOI, Seoul (KR); Seo Hyun CHOI, Seoul (KR)

(73) Assignees: Jae Ho CHOI, Seoul (KR); Hyun Kyu CHOI, Seoul (KR); Seo Hyun CHOI, Seoul (KR); Delta PDS CO., LTD., Seoul (KR)

(21) Appl. No.: 17/896,740

(22) Filed: Aug. 26, 2022

(30) Foreign Application Priority Data
Mar. 23, 2022 (KR) 10-2022-0036020

(51) Int. Cl. G06Q 10/06

(52) U.S. Cl. CPC G06Q 10/06316

(57) ABSTRACT

An approval object-based work management device includes a work note processing unit that creates a work note related to a specific work in the course of a project, a note chat room processing unit that creates a note chat room which is managed as a work object of the project and associated with the work note, an approval object creation unit that creates an approval object for processing an approval work for the work note through the note chat room, and an approval object processing unit that updates an approval status of the approval object according to work progress stages of the approval work and processes the approval work as completed when the last stage of the work progress stages is completed.

### CROSS-REFERENCE TO RELATED APPLICATION

This application claims priority, under 35 U.S.C. § 119(a), to Korean Patent Application No. 10-2022-0036020 (filed on Mar. 23, 2022) which is hereby incorporated by reference in its entirety.

### BACKGROUND

The present disclosure relates to work processing and management technology, and more particularly, to technology for effectively supporting execution of a project by objectifying various approval works that occur among participants of the project in the course of the project and providing management means through the objectified approval works.

In general, an Internet messenger corresponds to an application that transmits a message including text or graphics between users, and may be implemented as a chat room in which a plurality of users participates. In an embodiment, the Internet messenger may include a mobile messenger performed in a mobile environment (e.g., a mobile phone), and may include, for example, KakaoTalk, Line, WeChat, Facebook messengers, etc. Further, in the management and progress of a work, such Internet messengers are increasingly being used in various ways.

In particular, conventionally, a multi-party communication means has been provided to share messages or mentions between work participants in a process of work management in a project. However, as the size of the project increases and the structure becomes more complex, a more effective data sharing method is required for smooth communication between work participants.

In the communication process between the work participants, messages, mentions, and comments are shared through various interfaces such as web pages, shared folder systems, chat rooms. However, it may be very difficult to effectively understand the processing flow between approval-related parties in relation to an approval work in view of an individual.

### RELATED ART DOCUMENT

### Patent Document

Korean Patent Application Publication No. 10-2020-0020194 (2020.02.26)

### SUMMARY

In view of the above, the present disclosure provides an approval object-based work management device and method which is capable of increasing work efficiency by, when a work requiring approval occurs in the communication process between a plurality of users, allowing the approval progress to be effectively shared among parties related to the approval through an objectified management means so that the approval-related parties can grasp the approval flow.

In accordance with one embodiment, an approval object-based work management device includes: a work note processing unit that creates a work note related to a specific work in the course of a project; a note chat room processing unit that creates a note chat room that is managed as a work object of the project and associated with the work note; an approval object creation unit that creates an approval object for processing an approval work for the work note through the note chat room; and an approval object processing unit that updates an approval status of the approval object according to work progress stages of the approval work and processes the approval work as completed when the last stage of the work progress stages is completed.

The work note processing unit may restrictively allow revision of the work note depending on the approval status.

When the revision of the work note is detected, the work note processing unit may create and store a first version of the work note before the revision and a second version of the work note after the revision through versioning of the work note.

The note chat room processing unit may create and share a work message according to the work progress stages of the approval work through the note chat room.

When a creation request for the approval object is directly input through the work note, the note chat room processing unit may automatically create the note chat room associated with the work note.

When the creation request is input through the work note in a state in which the note chat room is created, the note chat room processing unit may create a new note chat room by receiving a selection of a corresponding creator.

The note chat room processing unit may create the note chat room including a creator of the approval object and at least one approval reviewer designated by the creator.

The work note processing unit may provide a time series list of previous versions of the work note including the first version through the second version of the work note, and the approval object processing unit may provide a link directly accessible to the second version of the work note through the approval object.

The approval object creation unit may create the approval object including at least one approval reviewer designated by a creator of the approval object.

The approval object processing unit may restrictively allows the creator and a person in charge of the current work progress stage to modify the at least one approval reviewer and the designated order included in the approval object.

When the at least one approval reviewer includes plural approval reviewers, the approval object processing unit may transfer the approval work in the designated order, and determine a change of the work progress stage depending on approval or rejection of the approval reviewer.

When the approval is processed by the last approval reviewer in the designated order, the approval object processing unit may create and display a summary of the approval work on the work note.

The approval object-based work management device may further include a reminder object processing unit that creates a reminder object related to the approval work according to the progress of each stage of the work progress stages and shares the reminder object through the note chat room.

The reminder object processing unit may provide a link directly accessible to the work note through the reminder object.

The approval object-based work management device may further include a user mention processing unit that creates a user mention related to the approval status according to the progress of each stage of the work progress stages and transfers the user mention to a person in charge related.

When the reminder object associated with the approval work is created, the user mention processing unit may create and transfer a user mention related to the reminder object to the corresponding person in charge.

In accordance with one embodiment, an approval object-based work management method may include: creating a work note related to a specific work in the course of a project through the work note processing unit; creating a note chat room managed as a work object of the project and associated with the work note through the note chat room processing unit; creating, through the approval object creation unit, an approval object for processing an approval work for the work note through the note chat room; and updating an approval status of the approval object according to work progress stages of the approval work and processing the approval work as completed when the last stage of the work progress stages is completed, through the approval object processing unit.

The disclosed technology may have the following effects. However, this does not mean that a specific embodiment should include all of the following effects or only the following effects, so the scope of the disclosed technology should not be construed as being limited thereby.

According to one embodiment of the present disclosure, when a work requiring approval occurs in the communication process between a plurality of users, the approval progress status is effectively shared among the approval-related parties through an objectified management means so that the approval-related parties can grasp the approval flow with ease, which increases efficiency of the work.

### BRIEF DESCRIPTION OF THE DRAWINGS

FIG. 1 is a view for explaining a work management system according to the present disclosure.

FIG. 2 is a diagram for explaining a system configuration of a work management device in FIG. 1.

FIG. 3 is a diagram for explaining a functional configuration of the work management device in FIG. 1.

FIG. 4 is a flowchart illustrating a method for managing a work based on an approval object according to the present disclosure.

FIG. 5 is a diagram for explaining a process of creating an approval object according to the present disclosure.

FIG. 6 is a diagram for explaining the work progress stages of the approval work according to the present disclosure.

FIG. 7 is a diagram for explaining the authority to modify the approval route according to the present disclosure.

FIG. 8 is a flowchart illustrating an approval object-based approval work processing process according to the present disclosure.

### DETAILED DESCRIPTION

Since the description of the present disclosure is merely an embodiment for structural or functional explanation, the scope of the present disclosure should not be construed as being limited by the embodiments described in the text. That is, since the embodiments may be variously modified and may have various forms, the scope of the present disclosure should be construed as including equivalents capable of realizing the technical idea. In addition, a specific embodiment is not construed as including all the objects or effects presented in the present disclosure or only the effects, and therefore the scope of the present disclosure should not be understood as being limited thereto.

On the other hand, the meaning of the terms described in the present application should be understood as follows.

Terms such as “first” and “second” are intended to distinguish one component from another component, and the scope of the present disclosure should not be limited by these terms. For example, a first component may be named a second component and the second component may also be similarly named the first component.

It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. Meanwhile, other expressions describing a relationship between components, that is, “between,” “directly between,” “neighboring to,” “directly neighboring to,” and the like, should be similarly interpreted.

It should be understood that the singular expression includes the plural expression unless the context clearly indicates otherwise, and it will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Identification symbols (for example, a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices storing data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

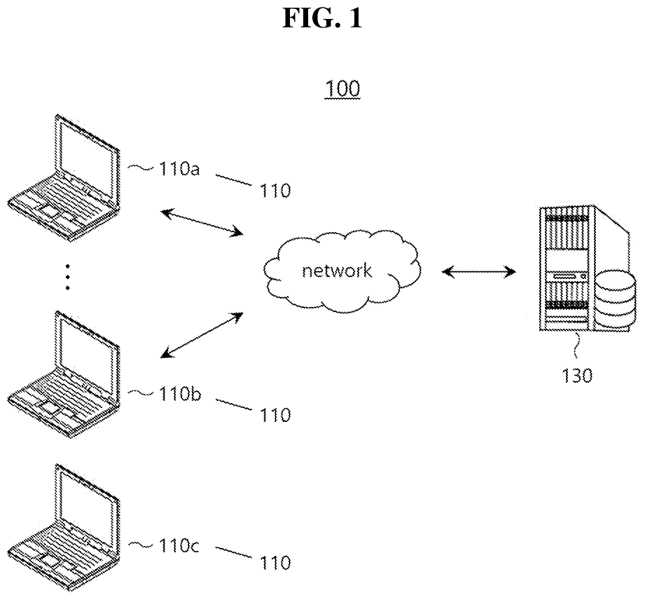

FIG. 1 is a view for explaining a work management system according to the present disclosure.

Referring to FIG. 1, the work management system 100 may include a plurality of user terminals 110 and a work management device 130.

The user terminal 110 may correspond to a computing device operated by a user. For example, the user terminal 110 may be implemented as a desktop, a laptop computer, a tablet PC, or a smartphone, but may be implemented in various devices without being limited to the above.

There may be one or more user terminals 110, and in this case, the one or more user terminals 110 may include any one of a first user terminal 110a, a second user terminal 110b, and a third user terminal 110c, or may include one or more of them. For convenience of description, the user terminal 110 used by a first user may be referred to as the first user terminal 110a, the user terminal 110 used by the second user may be referred to as the second user terminal 110b, and the user terminal used by the third user. 110 may be referred to as the third user terminal 110c.

In one embodiment of the present disclosure, a plurality of users may be included in one or more user groups. The one or more user groups may be referred to as a first user group, a second user group, a third user group, and the like. Meanwhile, one user may be simultaneously included in one or more user groups.

Further, a plurality of users may participate in a common project or work. In this case, one entire project may exist, and the entire project may include a plurality of independently conducted work projects. In addition, in association with each work project, work notes according to work progress stages may be created and stored, and in each of the work notes, various work histories (or work records) related to the corresponding work may be recorded.

Furthermore, various work objects associated with the entire project or each work project may be created and stored, and records regarding initiation, progress, and completion of individual works may be stored in the work object. For example, in the case of an entire project, each work project may correspond to a work object corresponding to a plan, and in the case of a work note, each task may correspond to a work object. Users participating in the entire project may correspond to work participants, and the work participants may be connected in a work project unit to share project-related data with each other and perform work-related communication. Moreover, the work participants may utilize various channels such as chat rooms, messages, and SNS for mutual communication.

In addition, various works performed within the entire project or individual work projects may be managed through a work processing flow, and each work may be managed through a work management item. Here, the work processing flow may be defined as a work processing flow between different types of work. In addition, the work management item may correspond to a tool for supporting communication between users in a work management process. For example, the work management item may be implemented as a chat room, a note, and a message.

In particular, a mutually dependent connection relationship may be formed between different types of work management items. For example, in the progress of the entire project, a project chat room may be created corresponding to each work project, and a work object corresponding to a plan may be created and shared within the project chat room. In this case, the corresponding work object may be managed while being subordinated to the corresponding project chat room. In addition, a note chat room may be created corresponding to each work note, and a work object corresponding to a task may be created and shared in the note chat room. In this case, the corresponding work object may be managed while being subordinated to the corresponding note chat room.

In addition, the work object, which is included in the project to be managed, may further include an approval object for processing approval related to the work, a reminder object for a reminder about the work, and the like. That is, the approval object may be created corresponding to an approval work, and may be shared with users related to the approval. Here, the approval work may correspond to a work in which a decision maker required to make a decision to confirm the contents during the project and to take effect accordingly. That is, the approval work may be created by designating at least one reviewer as the decision maker, and the final effect of the corresponding work may be created by the approval of the reviewer designated as the decision maker. If plural reviewers are designated for the approval work, the work may take effect upon approval of all reviewers. In addition, the reminder object may be created corresponding to a person in charge or work requiring a reminder, and may include reminder conditions such as reminder contents, period, and number of times.

In one embodiment, at least one of the user terminals 110 may be a mobile terminal, and may be connected to the work management device 130 through cellular communication or Wi-Fi communication. In another embodiment, at least one of the user terminals 110 may be a desktop, and may be connected to the work management device 130 through the Internet.

The work management device 130 may correspond to a computing device that can be connected to at least one user terminal 110 through a network. In one embodiment, the work management device 130 may manage at least one user group in which one user and another user associated with the one user are included as a member, that is, a work participant.

In one embodiment, the work management device 130 may be connected to the user terminal 110 through a dedicated agent installed in the user terminal 110. In this case, the dedicated agent may correspond to an agent program that is software capable of allowing the user terminal 110 and the work management device 130 to be interworked under the approval of the user terminal 110 when installed in the user terminal 110.

Meanwhile, the connection and coupling between the work management device 130 and the user terminal 110 described herein may correspond to one embodiment, and as a matter of course, may be changed and applied in various forms within a typical range depending on various operation environments.

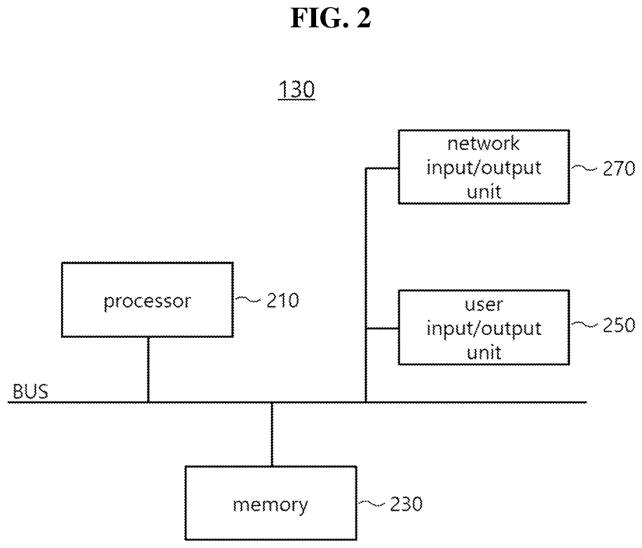

FIG. 2 is a diagram for explaining a system configuration of the work management device in FIG. 1.

Referring to FIG. 2, the work management device 130 may include a processor 210, a memory 230, a user input/output unit 250, and a network input/output unit 270.

The processor 210 may execute the approval object-based work management procedure according to the present disclosure, and may manage the memory 230 that is read or written in this process, and may schedule synchronization time between the volatile and non-volatile memories in the memory 230.

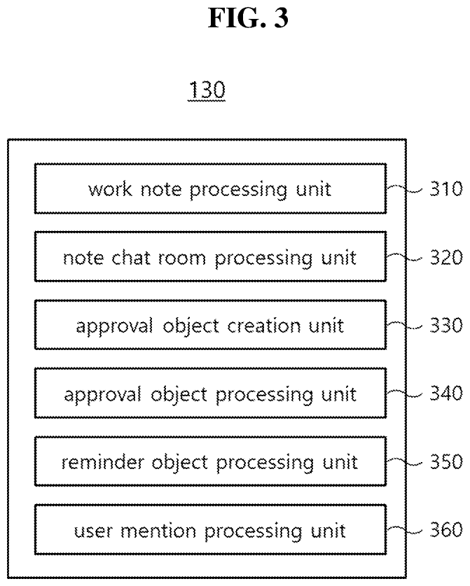

The processor 210 may control the overall operation of the work management device 130, and is electrically connected to the memory 230, the user input/output unit 250, and the network input/output unit 270 to control the flow of data therebetween. The processor 210 may be implemented as a central processing unit (CPU) or a graphics processing unit (GPU) of the work management device 130. The operation of the processor 210 will be described in detail later with reference to FIG. 3.

The memory 230 may include an auxiliary storage device that is implemented as a non-volatile memory, such as a solid state disk (SSD) or a hard disk drive (HDD), and used to store overall data required for the work management device 130, and a main storage device implemented as a volatile memory such as random access memory (RAM). As such, the memory 230 may be implemented as the volatile and non-volatile memories, and if implemented as the non-volatile memory, the memory 230 may be implemented to be connected through a hyperlink.

The user input/output unit 250 may include an environment for receiving a user input and an environment for outputting specific information to the user, and for example, may include an input device including or connected to an adapter such as a mouse, a trackball, a touch pad, a graphic tablet, a scanner, a touch screen, a keyboard, or a pointing device, and an output device including an adapter such as a monitor or a touch screen. In one embodiment, the user input/output unit 250 may correspond to a computing device which is accessible through remote access, and in such a case, the work management device 130 may serve as a server.

The network input/output unit 270 provides a communication environment to be connected to the user terminal 110 through a network, and may include an adapter for communication such as a local area network (LAN), a metropolitan area network (MAN), a wide area network (WAN), and a Value Added Network (VAN), for example. In addition, the network input/output unit 270 may be implemented to provide a short-distance communication function such as WiFi or Bluetooth or a wireless communication function of 4G or higher for wireless data transmission.

FIG. 3 is a diagram for explaining a functional configuration of the work management device in FIG. 1.

Referring to FIG. 3, the work management device 130 may be implemented to include a work note processing unit 310, a note chat room processing unit 320, an approval object creation unit 330, an approval object processing unit 340, a reminder object processing unit 350, and a user mention processing unit 360, and a control unit (not shown in FIG. 3).

The work note processing unit 310 may create a work note related to a specific work in the course of the project. That is, the work participants participating in the project may create work notes for work record and management, and to this end, the work note processing unit 310 may provide a dedicated interface for creating work notes. When the work note processing unit 310 receives a request for creation from a work participant, it may perform an operation of creating a work note in response to the request, and the created work note may be stored and managed in association with the corresponding project.

In one embodiment, the work note processing unit 310 may restrictively allow revision of the work note depending on the approval status of an approval object. In this case, the approval object may be created to process the approval work, and the approval status may correspond to status information that is changed according to the work progress stages of the approval work. For example, the approval status may have status values of ‘Create’, ‘Review’, ‘Approved’, and ‘Confirmed’ according to the work progress stages. The work note processing unit 310 may provide reliability of the approval work by restrictively allowing the revision of the work note while the approval object is created in the work note and the approval work is in progress.

For example, the work note processing unit 310 may give a writer of the work note the authority to revise only when the approval status corresponds to ‘Create’. Accordingly, the writer may revise the contents related to the approval work by revising the work note in the stage before the approval work proceeds to the review stage. Meanwhile, when the writer of the work note and the creator of the approval object are different, the work note processing unit 310 may give a revision authority to at least one of the writer of the work note and the creator of the approval object.

In one embodiment, when the revision of the work note is detected, the work note processing unit 310 may create and store each of a first version of the work note before the revision and a second version of the work note after the revision through versioning on the corresponding work note. The work note processing unit 310 may basically perform a versioning operation according to the revision of the work note when at least one approval object associated with the work note is created. The versioning operation with respect to the work note may be performed for the purpose of managing the contents before and after the revision based on the revision time of the work note. The work note processing unit 310 may manage the work note for each version according to versioning, and the second version of the work note created according to the last revision may be managed in connection with the approval object as the final note.

In one embodiment, the work note processing unit 310 may provide a time-series list of previous versions of the work notes including the first version through the work note of the second version. The work note processing unit 310 may connect the created work notes by version according to versioning, and may provide a means of accessing the work notes of the previous versions through the final note interconnected with the approval object. For example, the work note processing unit 310 may provide a function for checking information of the work notes of the previous versions on the work note of the second version corresponding to the version after revision with reference to the last revision. That is, when the ‘Previous note view’ menu implemented on the corresponding work note is selected by the work participant who has accessed the work note of the second version, the work notes of the previous versions may be arranged and displayed in time series order.

The note chat room processing unit 320 may create a note chat room that is managed as a work object of the project and associated with the work note. The work management device 130 may create and provide a note chat room as a work management item related to a work note through the note chat room processing unit 320. The note chat room may be basically provided for communication between the work participants participating in the work related to the work note, but when the approval object is created, the participation authority may be limited to only the approval-related parties related to the approval object. The note chat room may be interconnected to the work note through a unique link.

Further, the note chat room processing unit 320 may create dedicated containers for managing a plurality of note chat rooms created in association with the project. That is, when a note chat room is created, the note chat room processing unit 320 may manage the note chat room by inserting it into a dedicated container.

In one embodiment, the note chat room processing unit 320 may create and share a work message according to the work progress stages of the approval work through the note chat room. The note chat room processing unit 320 may share approval-related chat messages, work messages, and reminder messages in a time series order through the note chat room in which the approval-related parties participate. Accordingly, the approval-related parties can effectively check the approval flow through the messages shared in the note chat room.

In this case, the work progress stage of the approval work may be changed according to the processing result of the person in charge for each stage from the start to the end of the approval work. For example, when the creation of the approval object is completed by the creator, the corresponding approval work may be automatically started. Then, the approval work may be transferred to each approval reviewer in the order specified by the creator, and when approved by the last approval reviewer, it may be transferred back to the creator. When the final confirmation by the creator is completed, the corresponding approval work may be finally completed and terminated.

In this way, the approval work can be transferred to a designated person in charge of work for each work progress stage, so that the progress of the corresponding stage may be initiated, and after the corresponding person in charge of work processes it, the progress of the next stage can be started. In this case, the note chat room processing unit 320 may create work messages for when the progress of a specific stage is started or ended during the work progress stages, when the specific stage proceeds to the next stage, and the like, to be shared through the note chat room.

In one embodiment, the note chat room processing unit 320 may automatically create a note chat room associated with a work note when a request for creation of the approval object is directly input through the work note. The approval object may be created through the interface provided on the work note. That is, a work participant who wants to create an approval object may input a request for creation of the approval object through the interface. In this case, detailed information on approval may be additionally input to the request for creation of the approval object. The note chat room processing unit 320 may execute a creation operation of the approval object in response to the request for creation of the approval object. If there is no note chat room associated with the work note, the note chat room processing unit 320 may create a note chat room in a stage before the creation of the approval object. In this case, the work note and the approval object may be interconnected through the note chat room, and approval-related parties may participate in the note chat room.

In one embodiment, when a request for creation is input through a work note in a state in which the note chat room is created, the note chat room processing unit 320 may create a new note chat room by receiving a selection of the corresponding creator. For example, when a plurality of approval works occur for one work note, an approval object corresponding to each approval work may be created. Therefore, when a request to create a approval object is input in a state where at least one note chat room has already been created in the work note, the note chat room processing unit 320 may allow the creator who has input the creation request to choose whether to use the existing note chat room or whether to create a note chat room.

In one embodiment, the note chat room processing unit 320 may create a note chat room including the creator of the approval object and at least one approval reviewer designated by the creator. The note chat room processing unit 320 may create a new note chat room according to the selection of the creator, and in this case, the creator and approval-related parties designated by the creator may automatically participate in the created note chat room. Further, even after the note chat room is created, the note chat room processing unit 320 may transmit a chat room invitation message requesting participation to the note chat room in response to a request of the creator. For example, the creator of the approval object may newly add an approval reviewer or newly add a referrer of the approval work in the course of the approval work. In this case, the note chat room processing unit 320 may automatically join the approval reviewer or the referrer designated by the creator to the note chat room, or transmit a chat room invitation message to the corresponding party.

The approval object creation unit 330 may create an approval object for processing an approval work for a work note through a note chat room. The approval object may be created through a related menu even within the note chat room, and in this case, participants participating in the note chat room may correspond to referrers related to the corresponding approval work. That is, when an approval object is created, a work message related to the approval work can be shared through the note chat room, and participants in the note chat room can naturally share information about the approval work.

In one embodiment, the approval object creation unit 330 may create an approval object including at least one approval reviewer designated by the creator of the approval object. That is, the creator of the approval object may request the creation of the approval object while directly designating a person in charge of the approval work to review and process the approval work as the approval reviewer. In this case, the creator may also designate a review order among the approval reviewers. The approval object creation unit 330 may create an approval route for approval processing based on the approval reviewers designated by the creator, and may create an approval object by applying the approval route. Meanwhile, the creator of the approval object may selectively designate a reviewer, a review order, a review deadline, a revision authority, a final approval person, etc. in the process of creating the approval object, and the approval object creation unit 330 may create the approval object based on the selection of the creator of the approval object.

The approval object processing unit 340 may update the approval status of the approval object according to the work progress stages of the approval work, and may process the approval work as completed when the last stage of the work progress stages is completed. The work progress stage may be changed according to the processing result of a person in charge for each stage from the start to the end of the approval work, and when the work progress stage is changed, the approval work may be transferred to a new person in charge of the changed stage. In addition, when a change in the work progress stage is detected, the approval object processing unit 340 may change the approval status of the approval object according to the change, and when confirmation is completed after the approval operation is transferred back to the creator through the reviewer, the approval object processing unit 340 may process the corresponding approval work as finally completed.

In one embodiment, the approval object processing unit 340 may provide a link directly accessible to the second version of the work note through the approval object. Here, the second version of the work note may correspond to the work note after revision created according to the versioning operation by the work note processing unit 310. That is, the second version of the work note may correspond to the last revised work note with reference to the versioning time according to the revision of the work note. As a result, the approval object processing unit 340 may interconnect the approval object and the final work note through the link. The link between the approval object and the final work note may be added to the approval object or the final work note, and direct access from one party to the other may be possible through the link. For example, when a work participant wants to check the status of an approval work while accessing the final work note and checking related work details, he or she can directly access the approval object linked through the link using the related menu. Conversely, the work participant may directly access the final work note linked through the link while accessing the approval object and checking the approval status. To this end, when a versioning operation is detected by interworking with the work note processing unit 310, the approval object processing unit 340 may perform a link update operation between the approval object and the final work note.

In one embodiment, the approval object processing unit 340 may restrictively allow only the creator and the person in charge in the current work progress stage to modify at least one approval reviewer included in the approval object or the designated order. The creator who creates the approval object may directly designate a reviewer to review the approval work when creating the approval object. In this case, when there are plural reviewers, the creator of the approval object may also designate the order among the reviewers, i.e., the approval order. Therefore, basically, reviewers and review order may be designated when an approval object is created, but the reviewers and the review order (or approval route) may be changed during the approval process.

Specifically, the approval object processing unit 340 may minimize confusion due to changes in the approval work by restrictively giving only the creator of the approval object and the current person in charge of the approval work the authority to modify the reviewer and the review order. The current person in charge of the approval work may correspond to any one of the reviewers designated by the creator. For example, if work participant A creates an approval object and designates other work participants B, C, and D as reviewers sequentially, the approval work of the approval object is performed in the order of A, B, C, D, and A according to the work progress stages. If the person in charge of the current work progress stage is reviewer B, creator A or reviewer B can change the subsequent reviewers C and D or add another reviewer E.

In one embodiment, when there are plural approval reviewers, the approval object processing unit 340 may transfer the approval work in a designated order and determine a change of the work progress stage according to the approval or rejection of the approval reviewers. The work progress stages of the approval work may be initiated by the creation of the creator, and may be completed by the confirmation of the creator after the approval work has been passed through the reviewers and transferred back to the creator. The approval object processing unit 340 may transfer the approval work to the person in charge for each stage along the approval route during the work progress stages. In this case, each stage of the work progress stages may be started by being transferred to the person in charge of the corresponding stage, and may be completed by the processing of the person in charge of the corresponding stage. In addition, depending on the processing result of the person in charge of the corresponding stage, the approval work may progress to the previous stage or the next stage. For example, if the person in charge approves the approval work, the approval work may progress to the next stage, whereas if the person in charge rejects the approval work, the approval work may progress to the previous stage.

In one embodiment, the approval object processing unit 340 may create and display a summary of the approval work on the work note when approval is processed by the last approval reviewer according to the designated order. In this case, the summary of the approval work may include summary information about the creator of the approval work, the reviewer, and the approval details (e.g., approval item, approval time, order of approval, approval method, etc.). The approval object processing unit 340 may create a summary of the approval work and visualize it on the work note, so that other work participants can easily recognize that the approval work of the corresponding work note is finally approved.

The reminder object processing unit 350 may create a reminder object related to the approval work according to the progress of each stage of the work progress stages and share it through a note chat room. Here, the reminder object may be created for a reminder regarding the approval object, and may be created corresponding to a person in charge or work requiring the reminder. In addition, the reminder object may include reminder conditions such as reminder contents, period, and number of times.

For example, the reminder object may be created for work participant A, and may perform an operation of providing a reminder regarding various tasks to the work participant A. In addition, the reminder object may be created for task x, and may perform an operation of providing a reminder about task x to various work participants.

Further, the reminder object processing unit 350 may share the created reminder object through a note chat room in various ways. For example, the reminder object may be shared in the form of a message within the note chat room, or may be shared in the form of a mention for a specific participant. The reminder object processing unit 350 may provide a function to search, classify, and count the reminder object in the note chat room.

In one embodiment, the reminder object processing unit 350 may provide a link directly accessible to the work note through the reminder object. For example, when the reminder object is shared in the form of a reminder message in the note chat room, the reminder object processing unit 350 may add a link connected to the work note in the reminder message. Through this, a reminder subject in the note chat room can directly access the work note by selecting the corresponding reminder message. As another example, the note chat room may be implemented to provide search results regarding the reminder object, and in this case, the reminder subject may directly access the corresponding work note by selecting a specific reminder object from the search list.

The user mention processing unit 360 may create a user mention regarding the approval status according to the progress of each stage of the work progress stages and transfer it to the related person in charge. Here, the user mention may be implemented as a message shared within the note chat room, and may be implemented to designate at least one of the work participants and provide separate and visualized information only to the at least one designated. For example, in the case of a user mention designating work participant A, an unread count of the user mention may be additionally displayed to the work participant A when the user mention is shared within the chat room. That is, while the user mention is only shared as a general message with the other work participants B and C, the unread count of the user mention may be displayed in blue and shared with the work participant A together with a general message. Meanwhile, the user mention may be implemented and provided in various forms other than messages in the note chat room.

In one embodiment, when a reminder object associated with the approval work is created, the user mention processing unit 360 may create a user mention about the reminder object and transfer it to the corresponding person in charge. That is, the reminder object may be provided in the form of a reminder message in the note chat room, and may be processed and displayed as a user mention to the subject of the reminder. Through this, the subject of the reminder can additionally share as visualized information the number of unread, deadline information (if there is a deadline for work), elapsed days, etc. together with the reminder message.

The control unit (not shown in FIG. 3) may control the overall operation of the work management device 130, and manage the control flow or data flow between the work note processing unit 310, the note chat room processing unit 320, the approval object creation unit 330, and the approval object processing unit 340, the reminder object processing unit 350 and the user mention processing unit 360.

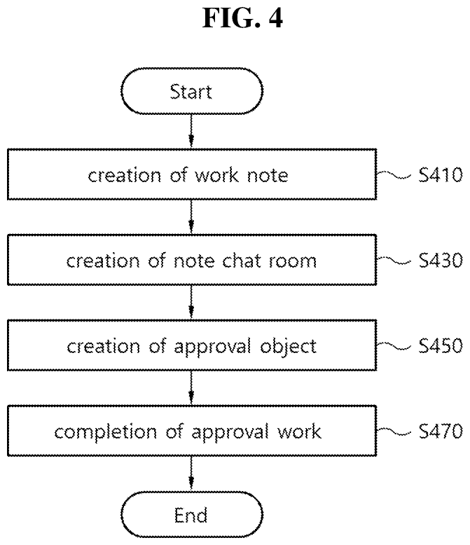

FIG. 4 is a flowchart illustrating a method for managing a work based on an approval object according to the present disclosure.

Referring to FIG. 4, the work management device 130 may create a work note related to a specific work in the course of a project through the work note processing unit 310 (step S410). The work management device 130 may create a note chat room that is managed as a work object of the project and associated with the work note through the note chat room processing unit 320 (step S430).

Further, the work management device 130 may create an approval object for processing the approval work for the work note through the note chat room through the approval object creation unit 330 (step S450). The work management device 130 may update the approval status of the approval object according to the work progress stages of the approval work through the approval object processing unit 340, and process the approval work as completed when the last stage of the work progress stages is completed (Step S470).

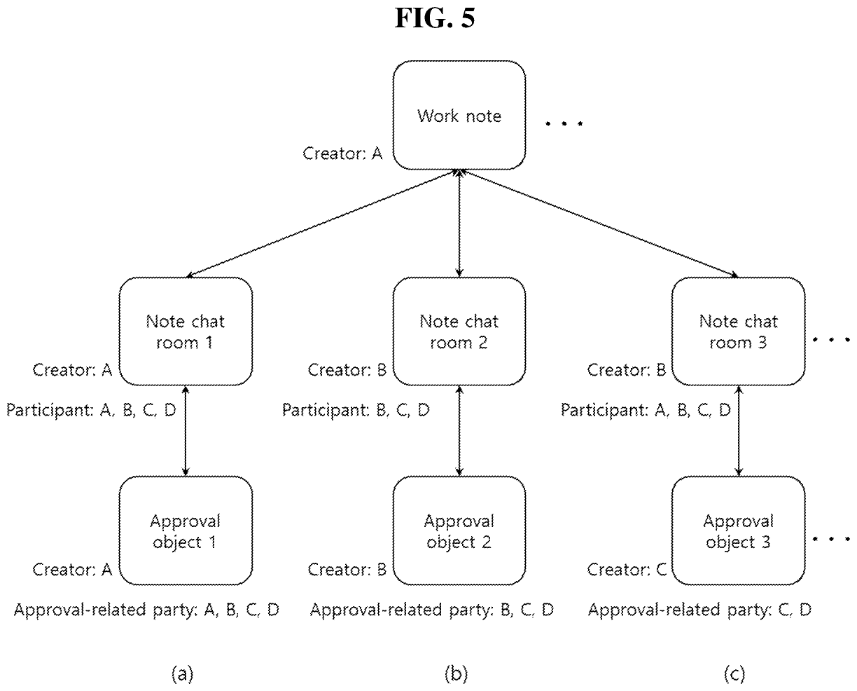

FIG. 5 is a diagram for explaining a process of creating an approval object according to the present disclosure.

Referring to FIG. 5, the work management apparatus 130 may receive a request for creation of an approval object from work participants in the course of a project, and may create the approval object in response to the creation request. To this end, the work management device 130 may provide an interface for inputting a request to create an approval object. For example, a work participant may request creation of an approval object in a work note, and may request creation of an approval object in a note chat room.

In the case of (a) of FIG. 5, creator A of the work note requests the creation of an approval object on the work note, and approval object 1 may correspond to the created result. The work management device 130 may create note chat room 1 associated with the work note according to the creation request of the creator A, and may create the approval object 1 associated with the note chat room 1. In the note chat room 1, the creator A and approval reviewers B, C, and D can participate as approval-related parties.

In the case of (b) of FIG. 5, creator B requests the creation of an approval object on the work note created by the creator A, and approval object 2 may correspond to the created result. The work management device 130 may create note chat room 2 associated with the work note according to the creation request of the creator B, and may create the approval object 2 associated with the note chat room 2. In the note chat room 2, the creator B and approval reviewers C and D designated by the creator B can participate.

In the case of (c) of FIG. 5, in the state where the work note is created by the creator A and note chat room 3 is created by the creator B, the chat room participant C requests the creation of an approval object and approval object 3 may correspond to the created result. The work management device 130 may create approval object 3 according to the creation request of creator C. Meanwhile, the work management device 130 may create a new note chat room separate from the existing note chat room 3 according to the selection of the creator C. That is, a new note chat room in which only the creator C and the approval reviewer D designated by the creator C participate can be created according to the selection of the creator C. In this case, the existing note chat room 3 and the new note chat room may be managed in association with the same work note.

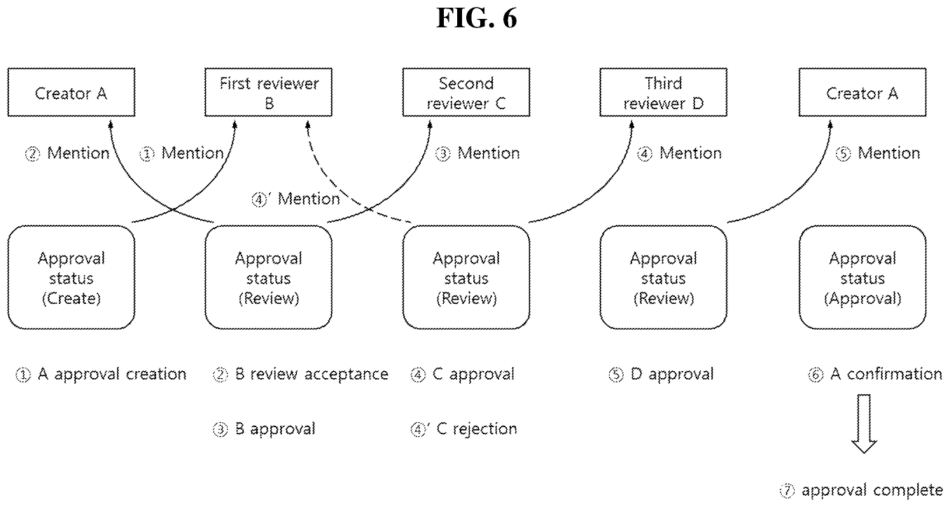

FIG. 6 is a diagram for explaining the work progress stages of the approval work according to the present disclosure.

Referring to FIG. 6, the work management device 130 may update the approval status of the approval object according to the work progress stages of the approval work through the approval object processing unit 340, and process the approval work as completed when the last stage of the work progress stages is completed.

For example, in FIG. 6, the creator A may write a work note and create an approval work (or approval object). If an approval work is created by the creator, the approval status of the corresponding approval work may correspond to ‘Create’. In addition, the creator A may sequentially designate B, C, and D as reviewers for the approval work. Accordingly, the work progress stages may be changed according to the processing result of the person in charge designated as the approval reviewer for each stage from the start to the end of the approval work.

In the Create state, it may be possible to revise the work note related to the approval work, and a versioning operation is performed according to the revision of the work note, so that the notes before and after the revision may be stored, respectively. In addition, the work management device 130 may create a user mention ‘Approval work has been created’ and provide the user mention to the first reviewer B who is the next approval reviewer designated by the creator A through the user mention processing unit 360. Meanwhile, if the first reviewer B does not click a review button consistently, the work management device 130 may create a reminder ‘Click the review button’ and provide the reminder to the first reviewer B after a preset time (e.g., 1 hour, 3 days, 2 weeks, 1 month, etc.) has elapsed.

When the first reviewer B accepts by clicking the review button, the approval status of the corresponding approval work may be changed to ‘Review’. In this case, the work management device 130 may create a user mention ‘Approval work has come in review stage’ and provide the user mention to the creator A through the user mention processing unit 360. Meanwhile, if the first reviewer B does not click an approve button or a reject button consistently, the work management device 130 create a reminder ‘Click approval button’ and provide the reminder to the first reviewer B after the preset time has elapsed.

When the first reviewer B processes the approval work by clicking the approval button, the corresponding approval work may be transferred to the second reviewer C, and the approval status may still correspond to ‘Review’. In this case, the work management device 130 may create a user mention ‘Approval is in review stage’ and provide the user mention to the second reviewer C through the user mention processing unit 360. Then, if the second reviewer C does not click the approval button or the rejection button consistently, the work management device 130 may create a reminder ‘Click approval button’ and provide the reminder to the second reviewer C after the preset time has elapsed.

When the second reviewer C processes the approval work by clicking the approve button, the corresponding approval work may be transferred to the third reviewer D, and the approval status may still correspond to ‘Review’, and a user mention and a reminder may be created and provided to the third reviewer D as in the case of the second reviewer C. Meanwhile, the second reviewer C may click the reject button instead of the approval button to process the approval work, and the approval work may be transferred to the first reviewer B that is the previous reviewer. In this case, a user mention ‘Approval work has been rejected’ may be provided to the first reviewer B.

When the third reviewer D processes the approval work by clicking the approval button, the corresponding approval work may be transferred back to the original creator A, and the approval status may be changed to ‘Approved’. In this case, the work management device 130 may create a user mention ‘Approval work has been approved’ and provide the user mention to the creator A through the user mention processing unit 360. Then, if the creator A does not click a confirmation button consistently, the work management device 130 may create a reminder ‘Click confirmation button’ and provide the reminder to the creator A after the preset time has elapsed.

Finally, when the creator A clicks the confirmation button, a work message ‘Approval work has been confirmed’ may be created and shared through the note chat room. In this case, a separate user mention may not be created. In addition, as a result of the confirmation processing of the creator A, the approval work may be treated as finally completed, and the approval work may be terminated.

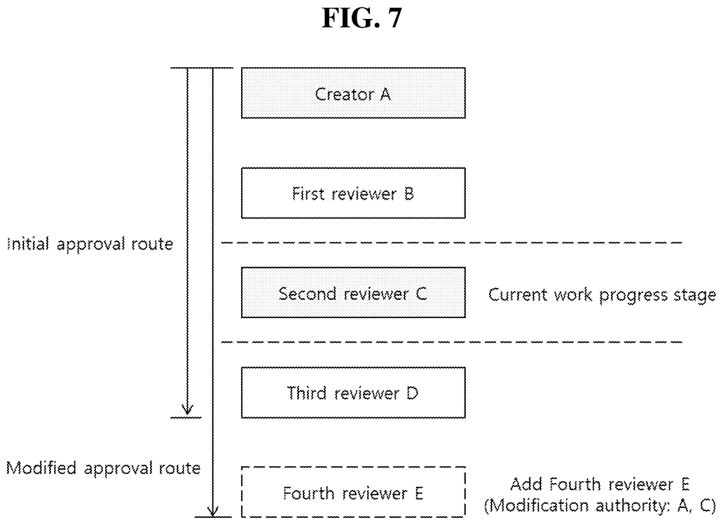

FIG. 7 is a diagram for explaining the authority to modify the approval route according to the present disclosure.

Referring to FIG. 7, the work management device 130 may restrictively allow only the creator and the person in charge in the current work progress stage to modify at least one approval reviewer included in the approval object or the designated order. In FIG. 7, the creator A may sequentially designate B, C, and D as approval reviewers while creating an approval object. In this case, the work management device 130 may transfer the approval work in the order of A, B, C, D, and A, which is the initial approval route. When the person in charge of the current work progress stage corresponds to the second reviewer C, the work management device 130 may give the creator A and the second reviewer C the authority to modify the approval route. That is, the creator A and the second reviewer C may modify the approval route to add a fourth reviewer E after the third reviewer D. In this case, according to the modified approval route, the approval work may be transferred and processed in the order of A, B, C, D, E, and A.

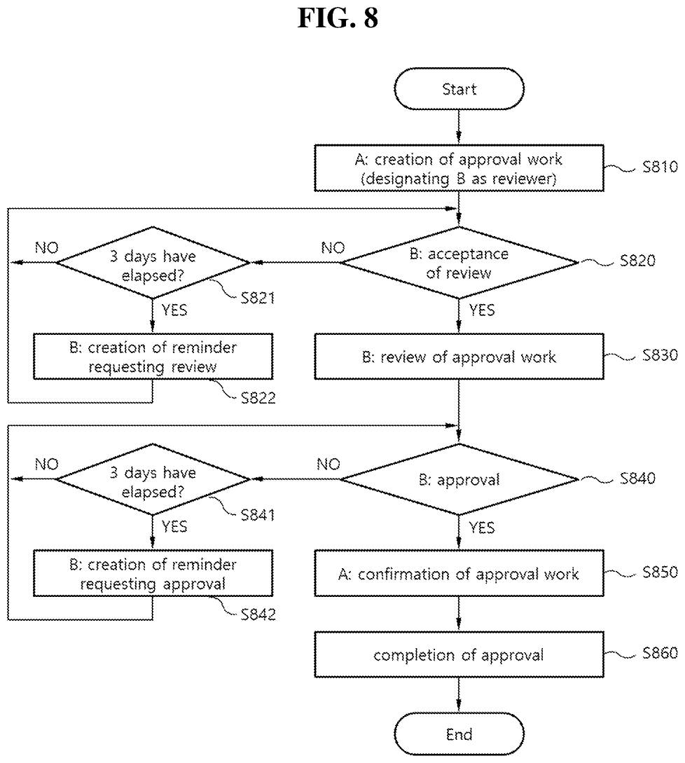

FIG. 8 is a flowchart illustrating an approval object-based approval work processing process according to the present disclosure.

Referring to FIG. 8, the work management device 130 may create an approval object for processing an approval work while a project is in progress. A creator A may create an approval work, and in this case, may designate another work participant B as an approval reviewer (S810). The reviewer B may accept the approval work by clicking the review button, and the work management device 130 may confirm whether the reviewer B accepts the approval work and transfer the approval work to the reviewer B (S820). If the reviewer B does not accept the approval work until 3 days have elapsed, the work management device 130 may create a reminder requesting the reviewer B to review according to the elapse of the reminder period for review acceptance (S821, S822).

The reviewer B may check the contents of the approval work and then approve or reject the approval work, and the work management device 130 may confirm the processing result of the reviewer B regarding the approval work and transfer the approval work to the creator A (S840). If the creator A has not processed the approval until 3 days have elapsed, the work management device 130 may create a reminder requesting the creator A to approve according to the elapse of the reminder period for the approval process (S841, S842).

The creator A may check the contents of the approval work and then process the confirmation of the approval work (S850), and accordingly, the approval process may be started and the approval work may be finally completed (S860).

As described above, the work management device 130 according to the present disclosure processes the approval work that occurs in connection with various works during the progress of the project and provides a communication means for effectively sharing the approval progress to the approval-related persons, thereby supporting the smooth progress of the project.

Although the present disclosure has been described with reference to the preferred embodiment above, those skilled in the art may variously modify and change the embodiment of the present disclosure within the scope of the present disclosure without departing from the spirit and scope of the present disclosure as set forth in the claims below.

[Description of Reference Numerals]

| | |
|---|---|
| 100: work management system | 110: user terminal |
| 130: work management device | 210: processor |
| 230: memory | 250: user input/output unit |
| 270: network input/output unit | 310: work note processing unit |
| 320: note chat room processing unit | 330: approval object creation unit |
| 340: approval object processing unit | 350: reminder object processing |
| | unit |
| 360: user mention processing unit | |

What is claimed is:

1. An approval object-based work management device comprising:
a work note processing unit that creates a work note related to a specific work in the course of a project;
a note chat room processing unit that creates a note chat room which is managed as a work object of the project and associated with the work note;
an approval object creation unit that creates an approval object for processing an approval work for the work note through the note chat room; and
an approval object processing unit that updates an approval status of the approval object according to work progress stages of the approval work and processes the approval work as completed when the last stage of the work progress stages is completed,
wherein the work progress stages are changed according to a processing result of a person in charge for each stage from the start to the end of the approval work.

2. The approval object-based work management device of claim 1, wherein the work note processing unit restrictively allows revision of the work note depending on the approval status.

3. The approval object-based work management device of claim 2, wherein when the revision of the work note is detected, the work note processing unit creates and stores a first version of the work note before the revision and a second version of the work note after the revision through versioning of the work note.

4. The approval object-based work management device of claim 1, wherein the note chat room processing unit creates and shares a work message according to the work progress stages of the approval work through the note chat room.

5. The approval object-based work management device of claim 1, wherein when a creation request for the approval object is directly input through the work note, the note chat room processing unit automatically creates the note chat room associated with the work note.

6. The approval object-based work management device of claim 5, wherein when the creation request is input through the work note in a state in which the note chat room is created, the note chat room processing unit creates a new note chat room by receiving a selection of a corresponding creator.

7. The approval object-based work management device of claim 1, wherein the note chat room processing unit creates the note chat room including a creator of the approval object and at least one approval reviewer designated by the creator.

8. The approval object-based work management device of claim 3, wherein the work note processing unit provides a time series list of previous versions of the work note including the first version through the second version of the work note, and
the approval object processing unit provides a link directly accessible to the second version of the work note through the approval object.

9. The approval object-based work management device of claim 1, wherein the approval object creation unit creates the approval object including at least one approval reviewer designated by a creator of the approval object.

10. The approval object-based work management device of claim 9, wherein the approval object processing unit allows the creator and a person in charge of the current work progress stage to modify the at least one approval reviewer and the designated order included in the approval object.

11. The approval object-based work management device of claim 9, wherein when the at least one approval reviewer includes plural approval reviewers, the approval object processing unit transfers the approval work in the designated order, and determines a change of the work progress stage depending on approval or rejection of the approval reviewer.

12. The approval object-based work management device of claim 11, wherein when the approval is processed by the last approval reviewer in the designated order, the approval object processing unit creates and displays a summary of the approval work on the work note.

13. The approval object-based work management device of claim 1, further comprising:
a reminder object processing unit that creates a reminder object related to the approval work according to the progress of each stage of the work progress stages and shares the reminder object through the note chat room.

14. The approval object-based work management device of claim 13, wherein the reminder object processing unit provides a link directly accessible to the work note through the reminder object.

15. The approval object-based work management device of claim 1, further comprising:
a user mention processing unit that creates a user mention related to the approval status according to the progress of each stage of the work progress stages and transfers the user mention to a person in charge related.

16. The approval object-based work management device of claim 15, wherein when the reminder object associated with the approval work is created, the user mention processing unit creates and transfers a user mention related to the reminder object to the corresponding person in charge.

17. An approval object-based work management method which is performed in an approval object-based work management device including a work note processing unit, a note chat room processing unit, an approval object creation unit, and an approval object processing unit, the method comprising:
creating a work note related to a specific work in the course of a project through the work note processing unit;
creating a note chat room managed as a work object of the project and associated with the work note through the note chat room processing unit;
creating, through the approval object creation unit, an approval object for processing an approval work for the work note through the note chat room; and
updating an approval status of the approval object according to work progress stages of the approval work and processing the approval work as completed when the last stage of the work progress stages is completed, through the approval object processing unit,
wherein the work progress stages are changed according to a processing result of a person in charge for each stage from the start to the end of the approval work.
